(19) United States
(12) Patent Application Publication
(10) Pub. No.: US 2010/0094544 A1
(43) Pub. Date: Apr. 15, 2010

(54) NAVIGATION DEVICE AND METHOD FOR THE GRAPHIC DISPLAY OF SUBREGIONS HAVING TRAFFIC RESTRICTIONS

(76) Inventors: Steffen Hess, Sachsenheim (DE); Marcus Fach, Stuttgart (DE)

Correspondence Address: KENYON & KENYON LLP, ONE BROADWAY, NEW YORK, NY, 10004, US

(21) Appl. No.: 12/450,390

(22) PCT Filed: Feb. 21, 2008
(86) PCT No.: PCT/EP2008/052104

§ 371 Date: Dec. 11, 2009

(30) Foreign Application Priority Data
Apr. 24, 2007 (DE) 10 2007 019 244.6

(51) Int. Cl. G01C 21/36; G08G 1/0967; G09G 5/02

(52) U.S. Cl. 701/208; 701/200; 345/597

(57) ABSTRACT

A navigation device is provided, which includes a storage unit for storing information about traffic restrictions for vehicles and for storing digital map data, and an output unit for a graphic display of a region such that subregions for which information about traffic restrictions for vehicles is stored are graphically labeled.

### BACKGROUND OF THE INVENTION

1. Field of the Invention

The present invention relates to a navigation device and to a method for displaying map regions.

2. Description of Related Art

A method for the suitable display of map regions via a driver information system is known from published German patent document DE 101 60 295 A1. In this instance, map regions are displayed through display map regions which are bordered by display edge lines and are filled in by surface colors.

### BRIEF SUMMARY OF THE INVENTION

In contrast to this, the navigation device according to the present invention and the method according to the present invention have the advantage that as part of a graphic display of a region via an output unit of a navigation device, those subregions for which information about traffic restrictions for vehicles is stored in a storage unit are graphically labeled. By this means, it is possible for a user to grasp visually, in a particularly simple, intuitive manner, subregions for which traffic restrictions for vehicles exist. Thus, the user has the option of guiding a vehicle where necessary along a route that does not lead through such a subregion.

According to one refinement of the present invention, the traffic restrictions for vehicles are a function of emissions of pollutants by vehicles, of pollutant groups of vehicles, and/or emission key numbers of vehicles. In this instance, pollutant groups are groups for the classification of motor vehicles based on emission values of pollutants of the motor vehicles. Such pollutant groups may be defined by the legislature, for example. Emission key numbers are key figures that are entered into the vehicle documents of a vehicle and allow for a classification of motor vehicles with regard to their emission of pollutants. This is advantageous since in the course of guiding a vehicle, it is possible for the user to avoid subregions of the kind for which there are traffic restrictions that are a function of emissions of pollutants by a vehicle. Such subregions are known as environment zones, among other names.

An additional advantageous refinement of the present invention provides that a subregion is graphically labeled in that an edge curve encircling the subregion is illustrated. This is advantageous since by this means the subregion is able to be recognized clearly by the user in its display.

Preferably, a subregion is graphically labeled through the display of an area. This has the advantage of a simple visual differentiation of the subregion from additional regions for which no traffic restrictions exist for vehicles.

Furthermore, in an additional refinement of the present invention it is possible to use a warning color to graphically illustrate an edge curve and/or an area. A warning color is a color whose color impression is produced by monochromatic or approximately monochromatic light. When perceived visually by a person, such light having a limited spectral bandwidth produces an increased attentiveness in the person and is therefore suitable for particularly highlighting subregions as part of a graphic labeling.

Warning colors include the colors red, yellow, or green, for example.

Furthermore, it is possible for edge curves and/or areas used to label a subregion to be illustrated transparently in such a manner that additional graphic elements that overlap with the edge curves and/or areas are also recognizable for a user. This is particularly advantageous since thus, as part of the graphic display, not only are the subregions labeled for the user, but additional information about the route guidance is made visible to the user through a recognizable display of additional graphic elements.

According to an additional example embodiment of the present invention, subregions for which different information about traffic restrictions for vehicles is stored are illustrated by edge curves and/or areas having different colors. This has the advantage that subregions for which different traffic restrictions are provided are visually recognizable in an intuitive manner for the user and may be distinguished in a simple manner.

An additional advantageous refinement of the present invention provides that the information about traffic restrictions of subregions is able to be specified in the navigation device by a user. This is advantageous since as part of the graphic labeling of subregions having traffic restrictions, it is possible to access not only information about traffic restrictions that was previously stored in a storage unit of the navigation device, but also additional information about traffic restrictions that may be specified by the user.

According to an additional example embodiment of the present invention, it is provided that the traffic restrictions are time-dependent. This has the advantage that subregions having traffic restrictions are displayed in a graphically labeled manner only at those points in time at which these traffic restrictions are also valid.

Preferably, a graphic display of subregions may be activated and/or deactivated by the user by an input in the navigation device via an input unit. This has the advantage that the user is able to decide personally whether a graphic labeling of subregions having traffic restrictions is advantageous for him.

An additional advantageous refinement of the present invention provides that vehicle data of a vehicle that include information regarding a pollutant group and/or an emission key value of the vehicle are stored in a storage unit. This is advantageous since as part of a graphic labeling of subregions having traffic restrictions, such information may be directly accessed without requiring an additional input of such information into the navigation device by the user.

According to an additional advantageous refinement of the present invention, the vehicle data may be specified by a user in the navigation device. This is advantageous since in this manner it is also possible to respond to vehicle data that previously were not stored in the storage unit.

Furthermore, it is advantageous that subregions are graphically labeled as a function of the vehicle data stored in the storage unit. This has the advantage that only those subregions for which traffic restrictions exist that are relevant for the vehicle are displayed in a graphically labeled manner.

According to an additional example embodiment of the present invention, by taking into account the stored vehicle data of the vehicle and a vehicle position determined by a position determination unit, it is determined whether a user is driving a vehicle into a subregion for which information about traffic restrictions for the vehicle is stored. If this is the case, a warning is output to the user via an output unit. This is advantageous since the user is warned by the navigation device before he possibly drives the vehicle into a subregion for which traffic restrictions exist for the vehicle, so that the user is prevented from violating a traffic rule.

Furthermore, it is advantageous that the navigation device has a data interface for reading data into the storage unit. By this means, it is possible to supplement and/or to modify the information that is stored in the storage unit about traffic restrictions for vehicles, so that this information is kept at a current status.

The method according to the present invention for route planning using a navigation device provides that the vehicle data stored in the storage unit and the information about traffic restrictions stored in the storage unit are taken into account as part of a calculation of a route from a starting location to a destination by a processing unit. This takes place such that the route calculated by the processing unit does not include route sections for which traffic restrictions for the vehicle are stored. This is advantageous since as part of a route planning, only those routes are calculated for which no traffic restriction for the vehicle exists at any point on the route.

### BRIEF DESCRIPTION OF SEVERAL VIEWS OF THE DRAWING

FIG. 1 shows a display of a region 1 for which a subregion is labeled graphically by an edge curve 11.

FIG. 2 shows a display of a region 1 for which a subregion is labeled graphically by an area 12.

FIG. 3 shows a display of a region 1 for which a subregion is labeled graphically by a transparent edge curve 13.

FIG. 4 shows a display of a region 1 for which a subregion is labeled graphically by a transparent area 14.

FIG. 5 shows a navigation device 100 having a storage unit 102, an output unit 103, an input unit 104, a position determination unit 105, a data interface 106, and a processing unit 107.

### DETAILED DESCRIPTION OF THE INVENTION

FIG. 5 shows a navigation device 100, which is provided with a storage unit 102 for storing information about traffic restrictions for vehicles. Furthermore, storage unit 102 is used to store digital maps. Preferably, it is possible to store information about traffic restrictions and to store digital map data in separate storage units. Furthermore, navigation device 100 is provided with an output unit 103 for the graphic display of a region. As part of the graphic display of the region, subregions for which information about traffic restrictions for vehicles are stored are displayed with labels.

Subregions are graphically labeled so that the driver may see the subregions for which traffic restrictions for vehicles exist. Through access to the information about traffic restrictions and digital map data stored in storage unit 102, it is possible to implement such a display of a region and its subregions, for which traffic restrictions exist, with the aid of output unit 103. According to an example embodiment of the present invention, a subregion may be graphically labeled in that the subregion is labeled by an edge curve 11, 13 encircling the subregion. This edge curve 11, 13 may preferably be a solid, dashed, or dotted curve. Edge curve 11, 13 may advantageously proceed exactly along lines that are displayed for the display of streets. However, this is not necessary. FIG. 1 shows the display of a region 1, in which an edge curve 11 is plotted to graphically label a subregion. FIG. 13 shows the display of a region 1, in which an edge curve 13 is plotted to graphically label a subregion.

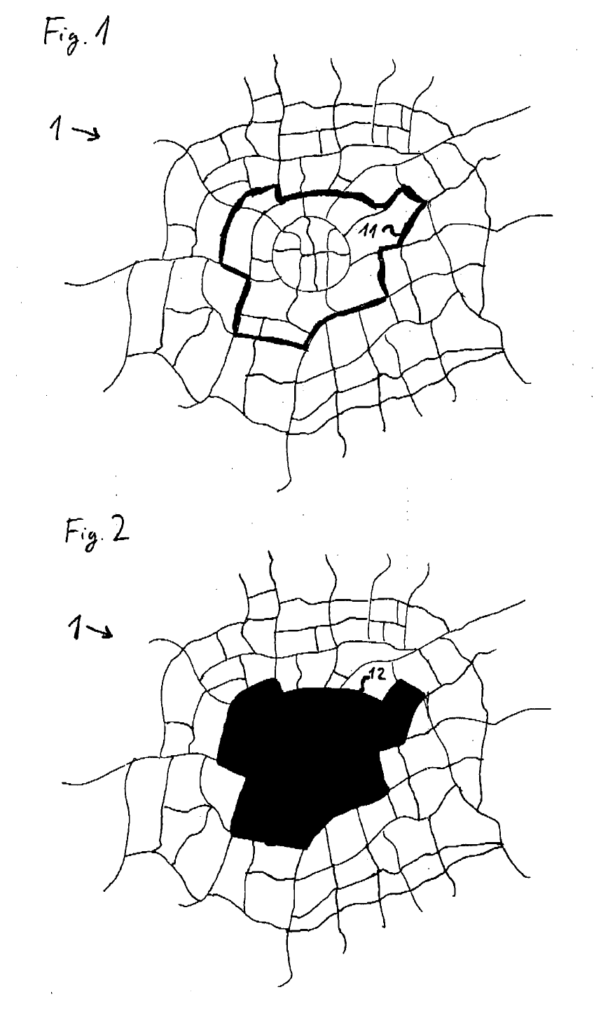

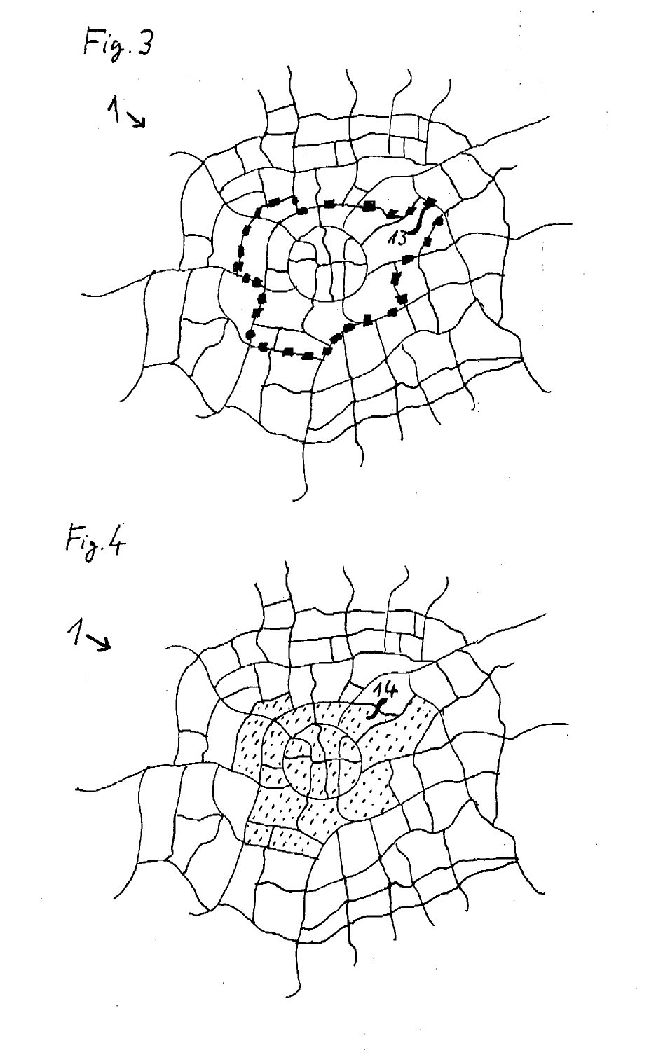

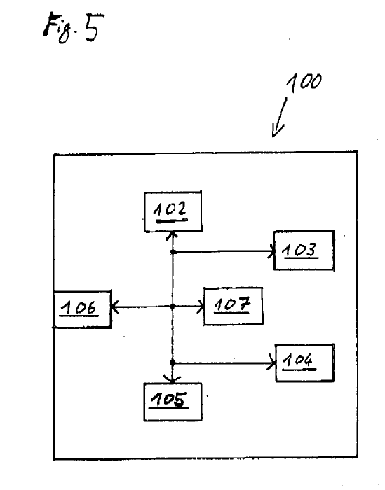

According to an additional example embodiment of the present invention, a subregion is labeled through the display of at least one area 12, 14. FIG. 2 shows region 1, in which an area 12 is plotted to graphically label a subregion. FIG. 4 shows region 1, in which an area 14 is plotted to label a subregion.

In particular, it is possible to use a warning color to illustrate an edge curve 11, 13 or an area 12, 14. By this means it is possible for the user to recognize in a particularly simple and intuitive manner a subregion having traffic restrictions while viewing the graphical display of the region.

Preferably, to label a subregion, edge curves 13 and/or areas 14 are displayed transparently so that additional displayed graphic elements that overlap with edge curves 13 and/or areas 14 are also recognizable for a user. FIG. 13 shows the display of a region 1, in which an edge curve 13 is plotted to label a subregion. In this instance, edge curve 13 is shown such that additional lines, for the display of streets, for example, that overlap edge curve 13 are still visible to the user. FIG. 4 shows the display of region 1, in which an area 14 is plotted to label a subregion. The transparent display of area 14 in FIG. 4 makes it possible to make visible to the user additional graphic elements such as lines for the display of streets, for example. In order to label a subregion graphically in such a manner that additional graphic elements remain visible for the user, it is possible to illustrate edge curves 11, 13 and/or areas 12, 14 with the aid of gray shading and/or color shading.

Furthermore, it is advantageous to illustrate subregions for which different information about traffic restrictions exists by different edge curves 11, 13 and/or different areas 12, 14. Different colors and/or shadings may be used for this purpose.

According to an additional advantageous refinement of the present invention, the traffic restrictions for vehicles are a function of emissions of pollutants by vehicles. Pollutants may be particles, such as soot particles or fine dust particles. Also, pollutants may be gases, such as carbon monoxide, carbon dioxide, nitrogen oxides, sulphur oxides, or also hydrocarbons, for example. Furthermore, it is possible for the traffic restrictions to be a function of pollutant groups. Also, it is possible for traffic restrictions for vehicles to be a function of emission key numbers of vehicles.

Furthermore, it is possible for the traffic restrictions for vehicles to be a function of a toll for a region, borders of restricted military areas, city borders, borders of city districts, or other types of administrative borders.

An additional advantageous refinement of the present invention provides that information about traffic restrictions of subregions is able to be specified in navigation device 100 by the user personally. By this means, the user has the opportunity to specify personally information regarding traffic restrictions of vehicles, which is not stored in storage unit 102.

For example, it is possible for the traffic restrictions for vehicles of subregions to be time-dependent. In this case, subregions are labeled graphically only if the traffic restrictions for vehicles in these subregions are valid at the time of the display.

Furthermore, it is advantageous that a graphic display of subregions may be activated and/or deactivated by the user by an input in navigation device 100 via an input unit 104. The user thus has the opportunity to decide personally whether a graphic labeling of subregions is advantageous for him.

For example, it is possible that data related to the vehicle in which navigation device 100 is located are stored in storage unit 102. These data are referred to by the term vehicle data. The pollutant groups and/or the emission key value of a vehicle may be determined with the aid of the vehicle data. Thus, it is preferably possible, as part of a graphic display of a region, to label graphically only those subregions for which traffic restrictions that are also relevant for the vehicle are stored in storage unit 102. It is preferably provided according to the present invention that the vehicle data are able to be specified in navigation device 100 by a user.

With the aid of a position determination unit 105, which is a part of navigation device 100 according to an additional example embodiment of the present invention, it is possible to take into account a vehicle position determined by position determination unit 105, as part of a graphic display of regions and subregions. This is performed such that when vehicle data stored in storage unit 102 is additionally taken into account, then a warning is output to the user if he drives the vehicle into a subregion for which traffic restrictions exist for the vehicle. In a first example embodiment, the warning is output before the vehicle is located in the subregion, 500 m before reaching the border of the subregion, for example. In a second example embodiment, the warning is output at the time at which the vehicle is located on the border of the subregion. Furthermore, in a third example embodiment, it is possible to output the warning during the time period in which the vehicle is located in the subregion. In principle, it is possible to combine the first, second, and third example embodiments into an additional example embodiment.

The output of the warning with the aid of output unit 103 may be carried out acoustically and/or visually. Output unit 103 has at least one display unit, preferably in the form of an LCD display. Furthermore, output unit 103 has means for the acoustic output of warnings, for example. A vehicle position determined by a position determination unit 105 may advantageously be displayed additionally as part of a graphic display.

According to an additional advantageous refinement of the present invention, navigation device 100 has a data interface 106 for reading data into storage unit 102, so that it is possible to update information about traffic restrictions for vehicles in storage unit 102. Data interface 106 may be designed for the transfer of data using the Worldwide Web, the wireless access protocol, the Internet protocol, the file transfer protocol, the traffic message channel, by short message service, or other data transmission methods. Also, it is possible, for example, to read in data via data interface 106 with the aid of data carriers such as CDs, DVDs, storage media having USB interfaces, memory cards or also hard disks. Furthermore, the data interface may be designed as a serial or a parallel data interface. An updating of the data stored in storage unit 102 with regard to traffic restrictions of vehicles may be initiated by the user but also by navigation device 100 itself.

The method according to the present invention for route planning via navigation device 100 performs a calculation of a route from a starting location to a destination using processing unit 107. In this instance, the information about traffic restrictions for vehicles stored in storage unit 102 is taken into account. This is performed such that the route calculated by processing unit 107 does not include route sections for which traffic restrictions for the vehicle exist. In this instance, the vehicle data stored in storage unit 102 are taken into account.

According to one exemplary embodiment, a user of a vehicle activates navigation device 100. As part of the graphic display of a region via output unit 103, navigation device 100 accesses information about traffic restrictions for vehicles that is stored in storage unit 102. If a region is displayed to the user via output unit 103, then subregions for which information about traffic restrictions for vehicles exists are graphically labeled via edge curves 11, 13 and/or areas 12, 14. The graphic labeling of subregions may be activated and/or deactivated by the user. If the traffic restrictions for vehicles are a function of emissions of pollutants by vehicles, then information regarding a pollutant group and/or an emission key value of the vehicle may be stored in storage unit 102.

Information about the pollutant group and/or the emission key value of the vehicle may furthermore be input by the user into navigation device 100 via input unit 104. The graphic labeling of subregions may be performed as a function of such information regarding pollutant groups or emission key values of vehicles. If position determination unit 105 determines a vehicle position, and if by taking into account the above-mentioned information a check is carried out to see whether the user is driving the vehicle into a subregion for which traffic restrictions exist for the vehicle, the user is made aware of this via the output of a warning via output unit 103. Advantageously, the position of the vehicle is displayed as part of the graphic display of the region. If traffic restrictions of subregions are time-dependent, the subregions are graphically labeled only if the traffic restrictions are also valid at the time of the display. The information regarding traffic restrictions for vehicles stored in storage unit 102 may be updated via a transfer of data via data interface 106. If the user would like to drive from a starting location to a destination, then he initiates the calculation of a route by navigation device 100 via processing unit 107. In this instance, processing unit 107 accesses the vehicle data, the stored information about traffic restrictions for vehicles, and the stored digital map data stored in storage unit 102. Processing unit 107 then ascertains a route from the starting location to the destination such that the calculated route does not include route sections for which traffic restrictions for the vehicle exist.

1-16. (canceled)

17. A navigation device, comprising:
an information storage unit storing information about traffic restrictions for vehicles and digital map data; and
an output unit configured to selectively provide a graphic display of a map area, wherein at least one subregion of the map area having associated stored information about traffic restrictions for vehicles is graphically identified.

18. The navigation device as recited in claim 17, wherein the traffic restrictions for vehicles are a function of at least one of: emission of pollutants by vehicles; pollutant groups of vehicles; and emission key numbers of vehicles.

19. The navigation device as recited in claim 18, wherein the subregion is identified by at least one of an edge curve encircling the subregion and a shaded area corresponding to the subregion.

20. The navigation device as recited in claim 19, wherein a warning color is used to illustrate the at least one of the edge curve and the shaded area.

21. The navigation device as recited in claim 19, wherein the at least one of the edge curve and the shaded area is illustrated transparently to enable additional displayed graphic elements overlapping with the at least one of the edge curve and the shaded area to be recognizable by a user.

22. The navigation device as recited in claim 18, wherein multiple subregions of the map area having different stored information about traffic restrictions for vehicles are displayed, each subregion being identified by at least one of an edge curve encircling the subregion and a shaded area corresponding to the subregion having different coloring.

23. The navigation device as recited in claim 18, wherein the information about traffic restrictions of the at least one subregion is able to be specified in the navigation device by a user.

24. The navigation device as recited in claim 18, wherein the traffic restrictions of the at least one subregion are time-dependent.

25. The navigation device as recited in claim 18, further comprising:
and input unit configured to enable a user to selectively activate and deactivate graphic identification of the at least one subregion of the map area.

26. The navigation device as recited in claim 18, wherein vehicle data of a vehicle are stored in the storage unit, the vehicle data including information regarding at least one of a pollutant group and an emission key value of the vehicle.

27. The navigation device as recited in claim 26, wherein the vehicle data are able to be specified by a user.

28. The navigation device as recited in claim 26, wherein the graphic identification of the at least one subregion is performed as a function of the vehicle data stored in the storage unit.

29. The navigation device as recited in claim 18, further comprising:
a position determination unit configured to determine a position of a vehicle;
wherein the navigation device is configured to determine, by taking into account the stored vehicle data of a vehicle and the vehicle position determined by the position determination unit, whether a vehicle is being driven into a subregion of the map area for which information about traffic restrictions for the vehicle is stored, and wherein the output unit outputs a warning when the vehicle is being driven into the subregion of the map area for which information about traffic restrictions for the vehicle is stored.

30. The navigation device as recited in claim 29, further comprising:
a data interface for reading into the storage unit data which include information about traffic restrictions for vehicles.

31. A method for vehicle route planning using a navigation device having (a) an information storage unit storing information about traffic restrictions for vehicles, digital map data, and vehicle data, (b) an output unit configured to selectively provide a graphic display of a map area, wherein at least one subregion of the map area having associated stored information about traffic restrictions for vehicles is graphically identified, and (c) a processing unit, the method comprising:
calculating a vehicle route from a starting location to a selected destination by a processing unit, wherein the calculation takes into account the vehicle data stored in the storage unit and the information about traffic restrictions for vehicles stored in the storage unit in such a manner that the calculated vehicle route excludes route sections having stored traffic restrictions for the vehicle; and
providing a graphic display of the calculated vehicle route.
